(19) United States
(12) Patent Application Publication
(10) Pub. No.: US 2025/0190983 A1
(43) Pub. Date: Jun. 12, 2025

(54) TECHNOLOGIES FOR EFFICIENTLY PROVIDING INSIGHTS FROM DATA SETS

(71) Applicant: The PNC Financial Services Group, Inc., Pittsburgh, PA (US)

(72) Inventors: Rajesh Kumar Saini, Mars, PA (US); Steve Farkas, Matthews, NC (US); Rajeshaker Kallam, Brecksville, OH (US); Vijay R. Morthala, Wesley Chapel, FL (US); Ming Ticchione, Cleveland, OH (US)

(21) Appl. No.: 18/603,447

(22) Filed: Mar. 13, 2024

Related U.S. Application Data
(60) Provisional application No. 63/607,613, filed on Dec. 8, 2023.

(51) Int. Cl. G06Q 20/38; G06Q 10/0639

(52) U.S. Cl. CPC G06Q 20/389; G06Q 10/06393

(57) ABSTRACT

Technologies for efficiently providing insights from one or more data sets include a compute device. The compute device includes circuitry configured to obtain a data analysis model, constructed with a user interface provided by the compute device, to be applied to financial transaction data indicative of financial transactions pertaining to a set of financial accounts. The circuitry is also configured to apply the data analysis model to the financial transaction data to identify one or more insights indicative of anomalous behavior. Further, the circuitry is configured to present the one or more insights in the user interface.

### CROSS-REFERENCE TO RELATED APPLICATION

This application claims the benefit, under 35 U.S.C. § 119 (e), of U.S. Provisional Patent Application No. 63/607,613, filed Dec. 8, 2023, the entirety of which is hereby expressly incorporated by reference herein.

### BACKGROUND

Typical computer systems utilized by institutions may collect data from a variety of sources and store that data in one or more databases for record keeping purposes. In many cases, personnel associated with an institution may wish to review summaries of the collected data to make strategic decisions for the

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for providing insights;

FIG. 2 is a simplified block diagram of at least one embodiment of a compute device of the system of FIG. 1;

FIGS. 3-4 are simplified block diagrams of at least one embodiment of a method for providing insights that may be performed by the system of FIG. 1;

FIGS. 5-13 are diagrams of user interfaces that may be produced by the system of FIG. 1; and

FIGS. 14-15 are simplified diagrams of operations that may be performed in connection with the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

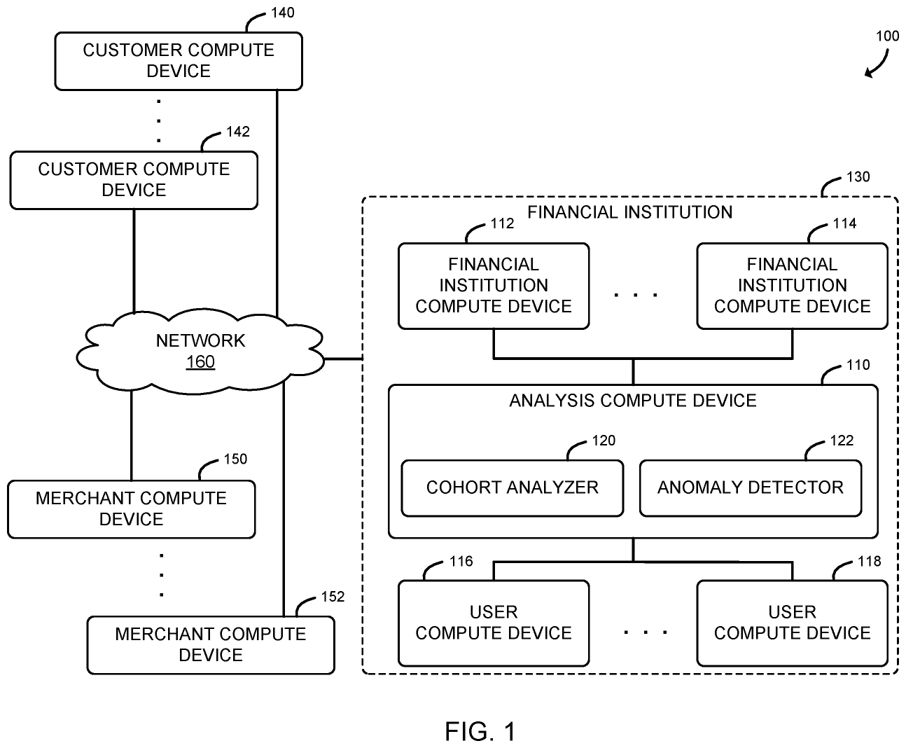

Referring now to FIG. 1, a system 100 for providing insights (e.g., from large data sets) includes, in the illustrative embodiment, an insight compute device 110 that is communicatively connected to a set of financial institution compute devices 112, 114. The financial institution compute devices 112, 114 process financial transactions on behalf of account holders (e.g., customers) of a financial institution 130 (e.g., a bank). The compute devices 110, 112, 114 may be located in a data center (e.g., a facility housing compute devices, thermal control equipment, power management equipment, and networking equipment to support the operations of the compute devices). Additionally, a set of user compute devices 116, 118 are, in the illustrative embodiment, communicatively connected to the insight compute device 110 to enable users (e.g., personnel associated with the institution 130) to interact with the insight compute device 110 through one or more user interfaces (e.g., graphical user interfaces produced by the insight compute device 110 and presented by one or more of the user compute devices 116, 118) as described in more detail herein.

A set of customer compute devices 140, 142 operated by people having financial accounts with the financial institution 130 (e.g., checking accounts, credit card accounts, etc.) may communicate with merchant compute devices 150, 152 to purchase goods or services from the corresponding merchants. Data indicative of those transactions (e.g., descriptions, amounts, etc.) is submitted to the financial institution 130 for processing (e.g., to enable the movement of money from the customer financial accounts to the corresponding merchants) and logging. In addition to processing data associated with the transactions themselves, the financial institution compute devices 112, 114, in the illustrative embodiment, maintain and update, on a continual basis, information pertaining to the customers associated with the accounts. Such information may include demographic information that may be obtained when each customer initially signs on with the institution 130 (e.g., through an account initiation process), through applications submitted to the financial institution 130 (e.g., loan applications, mortgage applications, etc.), and/or may be developed over time as the compute devices 110, 112 of the institution process inflows and outflows to and from the customer financial accounts.

Personnel associated with the institution 130 may seek to analyze data associated with the customers and financial transactions processed on their behalf to identify insights that could inform strategic decisions for the institution 130 (e.g., to enable the institution 130 to continually provide efficient and effective financial products and services for customers). In the illustrative embodiment, the insight compute device 110 supports such strategic decision making across a variety of products and functions of the financial institution 130, by providing an efficient mechanism to query data collected by the financial institution compute devices 112, 114 and identify anomalies (e.g., insights) in the data that could inform strategic decisions. That is, the insight compute device 110 eliminates the need for specialized teams with subject matter expertise and technical knowledge to expend considerable time and resources in developing customized software to query, analyze, and present one or more summaries of the data.

In the illustrative embodiment, the insight compute device 110 may identify anomalous behavior within a data set (e.g., data pertaining to a retail lending portfolio) by clustering financial accounts with similar attributes and identifying anomalous behavior within those clusters. The insight compute device 110 may also enable business users, such as product and analytics personnel, to investigate customer, account, and transaction data. Further, the insight compute device 110, in the illustrative embodiment, may enable users to easily design data analysis models, explore data with cohort analysis, and drill down into underlying account data. The insight compute device 110, in operation, may support any personnel managing some form of risk and can be used for insights related to operational and credit risk management, among other forms of risk management or decision-making operations. For a defined use case, the insight compute device 110, in the illustrative embodiment, provides the user the ability to perform deeper dives using various filters and analyze tree nodes and the underlying cohorts. In these use cases, users may define a key performance indicator (KPI) and decide the reporting or aggregation hierarchy (e.g., in the format of a tree structure) and define how nodes (e.g., segments) of the structure are aggregated up to a total population (e.g., thereby defining a data analysis model).

The insight compute device 110, in the illustrative embodiment, enables a deep dive analysis by utilizing a cohort analyzer 120 and an anomaly detector 122, each of which may be embodied as software (e.g., computer executable instructions), hardware (e.g., circuitry), and/or a combination thereof to perform the associated functions. The cohort analyzer 120, in the illustrative embodiment, provides summarized KPIs by attributes of interests. These attributes can be defined manually by subject matter expert's domain knowledge and/or through execution of one or more machine learning algorithms. The anomaly detector 122, in the illustrative embodiment, provides time series charts (e.g., presented in a user interface) that may include historical actual values and thresholds identified by the insight compute device 110 from the historical values. When the data points are less than a predefined amount (e.g., ten), in some embodiments, the anomaly detector 122 may cause the chart to display historical actual data values for the primary KPI (e.g., in a line having a color, pattern, or other assigned visual characteristic). When the data points satisfy the predefined amount (e.g., equal to or more than 10), the anomaly detector 122 may additionally execute one or more anomaly detection algorithms to flag any outliers. Once data is populated per design of analysis, users may review and analyze the reports (e.g., summaries) to learn insights, such as identifying any outlier(s) and/or understanding drivers of KPIs. These insights can then be shared among business groups for further analysis, which may include retrieving account/customer/transaction level data to review.

In the illustrative embodiment, the insight compute device 110 provides a user interface with which a user may design the elements of a data analysis model (such as tree structure, define KPIs, cohorts, filters, etc.) to be in the data analysis and reporting of insights. The insight compute device 110 may leverage an engine (e.g., Apache Spark) for executing data engineering, data science, and machine learning on single compute device or across distributed compute devices. The user interface may connect to such an engine through an interface (e.g., PySpark SQL) to query and create a data set that feeds into the user interface component to create the final report presented to a user. In at least some embodiments, the user interface enables users to define an SQL query (e.g., a PySpark SQL query), which may then be passed to an underlying application (e.g., a Python application) executed by one or more of the compute devices 110, 112, 114 (e.g., utilizing a scalable distributing computing framework, such as Apache Hadoop). The insight compute device 110 may produce reports with insights (e.g., corresponding to the designs (e.g., data analysis models) provided through the user interface) on an as-requested basis and/or on a periodic basis (e.g., based on scheduled jobs).

While a single insight compute device 110, two financial institution compute devices 112, 114, two user compute devices 116, 118, two customer compute devices 140, 142, and two merchant compute devices 150, 152 are shown for simplicity and clarity, it should be understood that the number of compute devices, in practice, may range in the tens, hundreds, thousands, or more. Likewise, it should be understood that the compute devices 110, 112, 114, 116, 118, 140, 142, 150, 152 may be distributed differently or perform different roles than the configuration shown in FIG. 1. Further, though shown as separate compute devices 110, 112, 114, 140, 142, 150, 152 in some embodiments, the functionality of one or more of the compute devices 110, 112, 114, 140, 142, 150, 152 may be combined into fewer compute devices and/or distributed across more compute devices than those shown in FIG. 1.

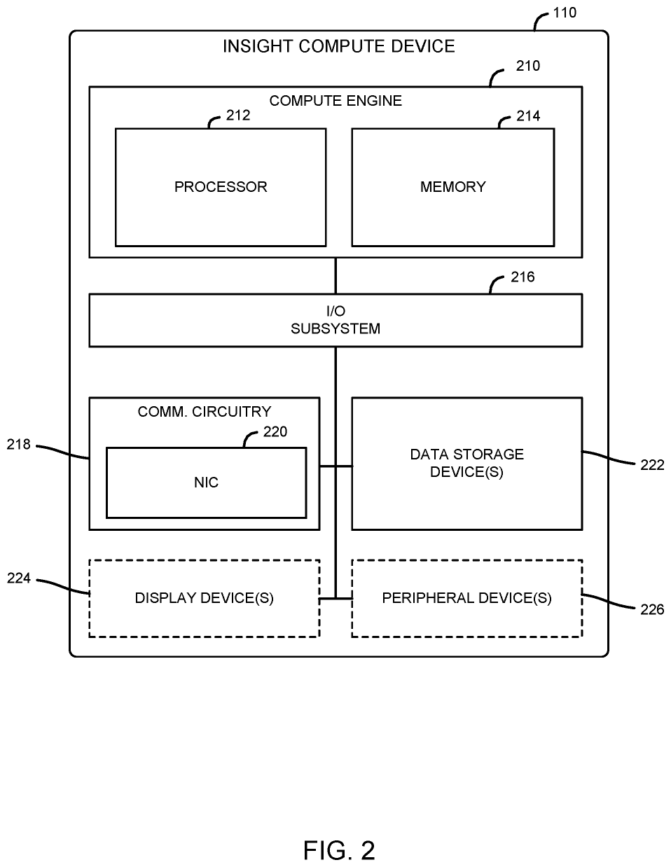

Referring now to FIG. 2, the illustrative insight compute device 110 includes a compute engine 210, an input/output (I/O) subsystem 216, communication circuitry 218, and one or more data storage devices 222. In some embodiments, the insight compute device 110 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the insight compute device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as database records, applications, libraries, and drivers.

The compute engine 210 is communicatively coupled to other components of the insight compute device 110 via the I/O subsystem 216, which may be embodied as circuitry and/or components to facilitate input/output operations with the compute engine 210 (e.g., with the processor 212 and the main memory 214) and other components of the insight compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the insight compute device 110, into the compute engine 210.

The communication circuitry 218 may be embodied as any communication circuit, device, or collection thereof, capable of enabling communications over a network between the insight compute device 110 and another device (e.g., a compute device 112, 114, 116, 118, 140, 142, 150, 152, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the insight compute device 110 to connect with another compute device (e.g., a compute device 112, 114, 116, 118, 140, 142, 150, 152, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the insight compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the insight compute device 110 are housed in a single unit. However, in other embodiments, the components may be in separate housings, in separate racks of a data center, and/or spread across multiple data centers or other facilities. The compute devices 112, 114, 116, 118, 140, 142, 150, 152 may have components similar to those described in FIG. 2 with reference to the insight compute device 110. The description of those components of the insight compute device 110 is equally applicable to the description of components of the compute devices 112, 114, 116, 118, 140, 142, 150, 152. Further, it should be appreciated that any of the devices 112, 114, 116, 118, 140, 142, 150, 152 may include other components, sub-components, and devices commonly found in a computing device, which are not discussed above in reference to the insight compute device 110 and not discussed herein for clarity of the description.

In the illustrative embodiment, the compute devices 110, 112, 114, 116, 118, 140, 142, 150, 152, are in communication via a network 160, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

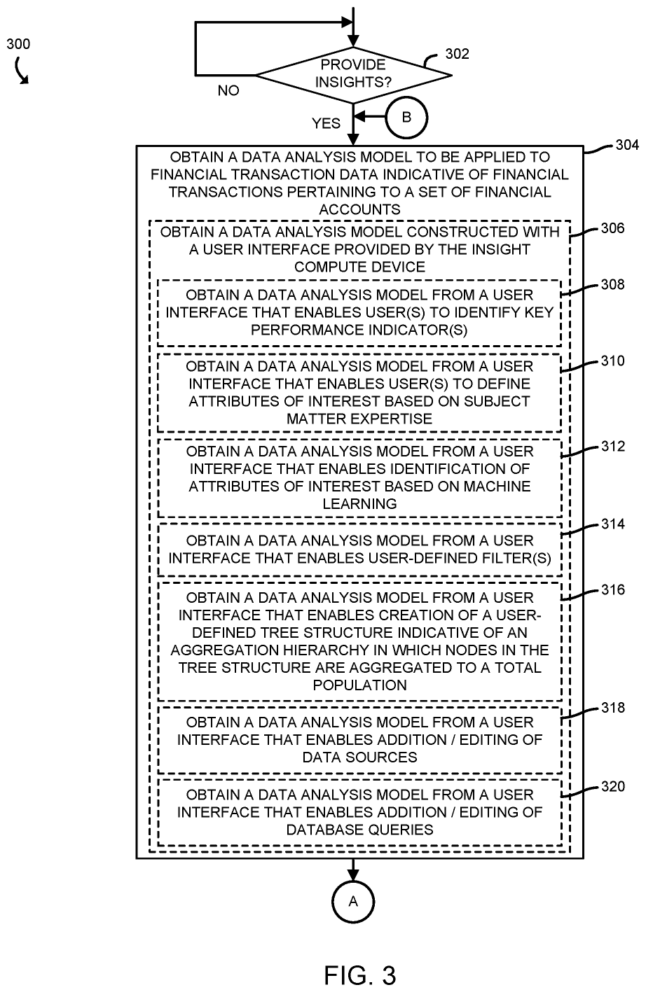

Referring now to FIG. 3, the system 100, and more specifically, the insight compute device 110, in the illustrative embodiment, may perform a method 300 for efficiently providing insights from one or more data sets (e.g., financial transaction data). The method 300 begins with block 302 in which the insight compute device 110 determines whether to provide insights. In doing so, the insight compute device 110 may determine to provide insights in response to a determination that a configuration setting (e.g., in memory 214 or in storage 222) indicates to do so, in response to receiving a request from another compute device (e.g., a user compute device 116, 118) to do so, and/or based on other factors. Regardless, in response to a determination to provide insights, the method 300 advances to block 304 in which the insight compute device 110 obtains a data analysis model. In the illustrative embodiment, the data analysis model is configured to be applied to financial transaction data (e.g., data collected and/or produced by the institution compute devices 112, 114) indicative of financial transactions pertaining to a set of financial accounts (e.g., accounts of the consumers).

As indicated in block 306, the insight compute device 110, in the illustrative embodiment, obtains a data analysis model that has been constructed with a user interface. The user interface, in the illustrative embodiment, is provided by the insight compute device 110. For example the user interface may be provided as executable instructions and data (e.g., hyper-text markup language, JavaScript, etc. and data, such as image data) to a web browser or other rendering engine executed on a corresponding user compute device 116, 118 for presentation to a user. As indicated in block 308, the insight compute device 110 may obtain the data analysis model from a user interface that enables users to identify one or more key performance indicators. Further, and as indicated in block 310, the insight compute device 110 may obtain the data analysis model from a user interface that enables users to defined attributes of interest, based on subject matter expertise. As indicated in block 312, the insight compute device 110 may obtain the data analysis model from a user interface that enables identification of one or more attributes of interest based on machine learning (e.g., execution of one or more machine learning algorithms).

Still referring to FIG. 3, in obtaining a data analysis model, the insight compute device 110 may obtain the data analysis model from a user interface that enables user-defined filters (e.g., the user may select one or more filters to be applied to a data set for analysis), as indicated in block 314. Additionally, in obtaining the data analysis model, the insight compute device 110 may obtain the data analysis model from a user interface that enables creation of a user-defined tree structure. The tree structure may be indicative of an aggregation hierarchy in which nodes (e.g., segments) in the tree structure are aggregated to a total population, as indicated in block 316. The insight compute device 110 may obtain the data analysis model from a user interface that enables the addition and/or editing of data sources, as indicated in block 318. Further, and as indicated in block 320, the insight compute device may obtain the data analysis model from a user interface that enables the addition and/or editing of database queries (e.g., structured query language (SQL) statements).

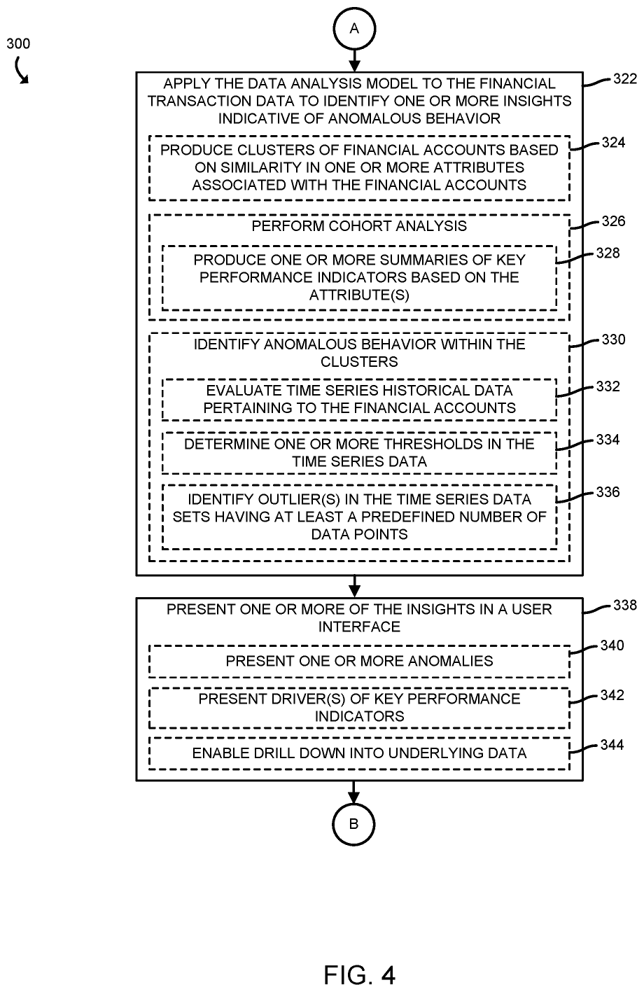

Referring now to FIG. 4, in the illustrative embodiment, the insight compute device 110 subsequently applies the data analysis model (e.g., obtained in block 304) to the data (e.g., financial transaction data) to identify one or more insights. The insights, in the illustrative embodiment, may be indicative of anomalous behavior (e.g., data points that fall outside of statistically-determined thresholds, previously unknown relationships in the data that have a statistically significant impact on key performance indicators, etc.), as indicated in block 322. In doing so, the insight compute device 110, in the illustrative embodiment, produces clusters of financial accounts based on similarity (e.g., falling within a predefined range of each other) in one or more attributes (e.g., attributes of interest) associated with the financial accounts, as indicated in block 324. The insight compute device 110 may perform cohort analysis (e.g., behavioral analytics in which groups or clusters of individuals are analyzed to determine their usage patterns based on their shared attributes to track and understand their actions) as indicated in block 326. In doing so, the insight compute device 110 may produce one or more summaries of key performance indicators (e.g., the key performance indicators identified in blocks 308, 310 of FIG. 3) based on the attributes (e.g., the attributes of interest), as indicated in block 328. Further, in the illustrative embodiment, the insight compute device 110 identifies anomalous behavior (e.g., anomalous behavior) within the clusters (e.g., the clusters from block 324), as indicated in block 330. In doing so, and as indicated in block 332, the insight compute device 110 may evaluate time series historical data pertaining to the financial accounts, as indicated in block 332. Further, the insight compute device 110 may determine one or more thresholds in the time series data (e.g., based on a defined number of standard deviations), as indicated in block 334. In addition, the insight compute device 110 may identify one or more outliers in any time series data sets that have at least a predefined number of data points (e.g., ten or more data points), as indicated in block 336.

Continuing the method 300, the insight compute device 110 presents one or more of the insights in a user interface (e.g., presented on a user compute device 116, 118), as indicated in block 338. In doing so, and as indicated in block 340, the insight compute device 110 may present one or more anomalies. Additionally, in the illustrative embodiment, the insight compute device 110 presents one or more drivers of one or more key performance indicators (e.g., attributes or combinations of attributes that have a significant impact on a key performance indicator), as indicated in block 342. Further, the insight compute device 110 may enable drill down into underlying data (e.g., present, in response to a selection of a summarized representation of a data set, the underlying data set), as indicated in block 344. Subsequently, the method 300 loops back to block 302 to potentially repeat the process (e.g., obtain a data analysis model, apply the data analysis model, and present one or more insights). While the method 300 is described in a particular order, for simplicity and clarity, it should be understood that operations in the method 300 may be performed in a different order or concurrently in some embodiments. For example, the operations of the method 300 may be performed in concurrent threads or processes, in which the insight compute device 110 is obtaining a data analysis model in one thread while concurrently (e.g., in a separate thread) applying a different data analysis model that has already been obtained.

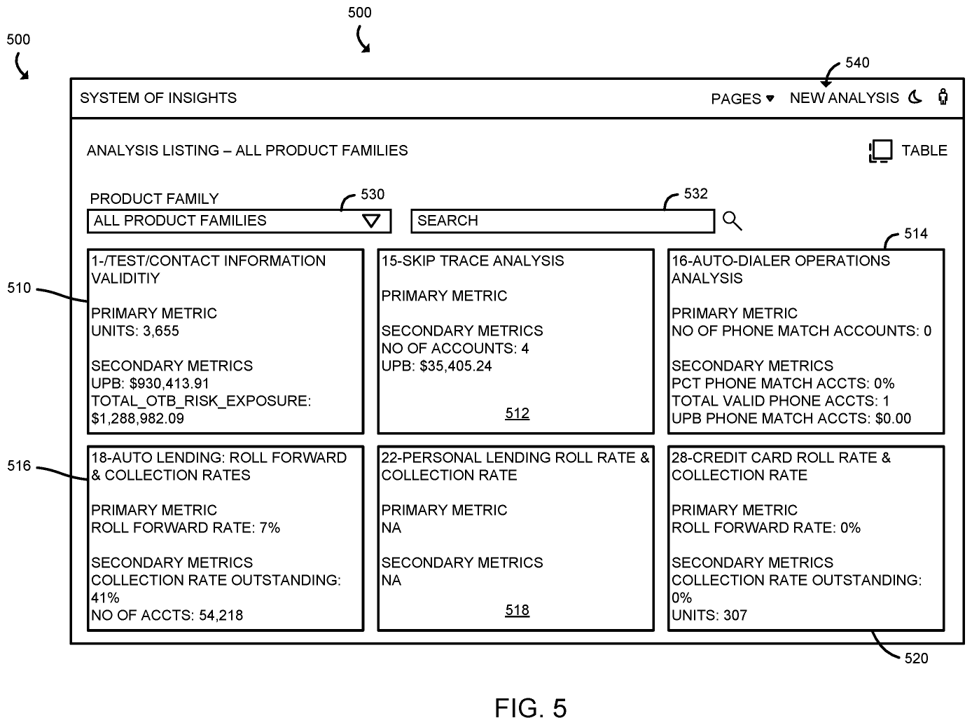

Referring briefly to FIG. 5, an embodiment of user interface 500 that may be provided by the insight compute device 110 includes a set of data analysis models 510, 512, 514, 516, 518, 520 available for use (e.g., editing, application to data sets, viewing the results of application to a data set). The set may be filtered according to user interface elements 530, 532. User interface element 530 enables selection of a product family from a drop-down list. User interface element 532 enables a user to enter a term to search for within the set of data analysis models 510, 512, 514, 516, 518, 520. In response to detecting a selection of the user interface element 540, the insight compute device 110 provides a user interface to enable a user to design a new data analysis model.

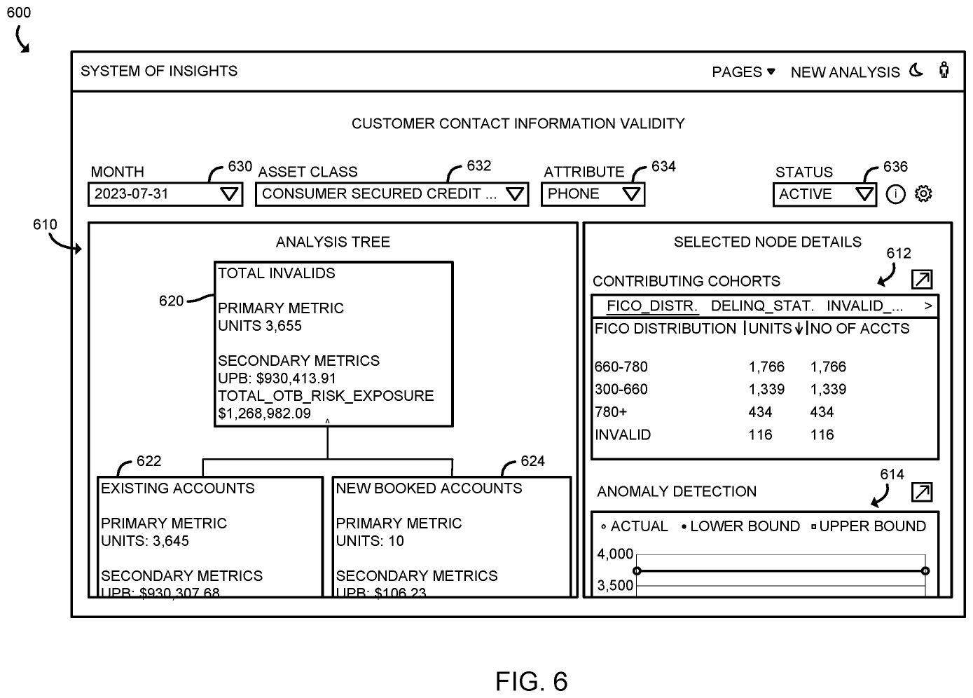

Referring to FIG. 6, an embodiment of a user interface 600 that may be provided by the insight compute device 110 includes a section 610 in which an analysis tree may be constructed and edited. The analysis tree includes multiple nodes (e.g., segments) 620, 622, 624. As indicated, segments of a population associated each of the nodes 622, 624 are aggregated into a total population represented by the node 620. In the sections 612, 614, details regarding the selected node (e.g., node 620) are displayed. In the section 612, information regarding contributing cohorts (e.g., attributes of interest) is displayed. In the illustrative embodiment, the information relating to the cohorts is displayed in a table format, with one or more sortable columns. Cohorts (e.g., attributes of interest) may be entered by a user (e.g., based on a subject matter expert's domain knowledge) and/or through the execution of one or more machine learning algorithms. In the section 614, anomaly detection information is displayed. In the illustrative embodiment, the anomaly detection information is displayed as a set of trend lines, with a trend line for actual data, a trend line representing a lower bound, and a trend line representing an upper bound. Filters 630, 632, 634, 636 enable the user to limit the presented information to a particular month, asset class, attribute, and/or status.

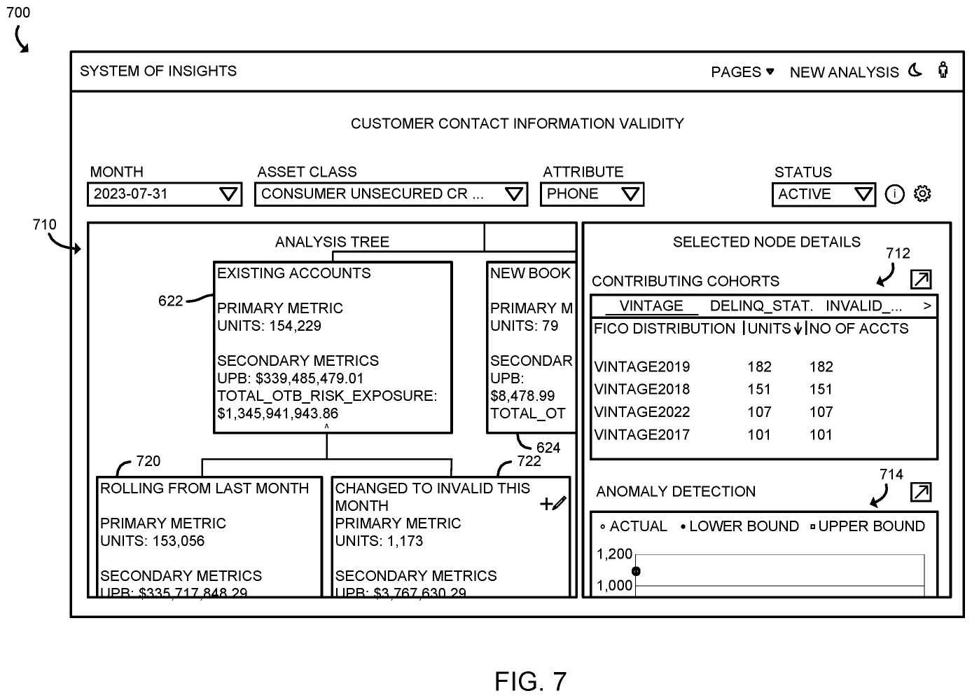

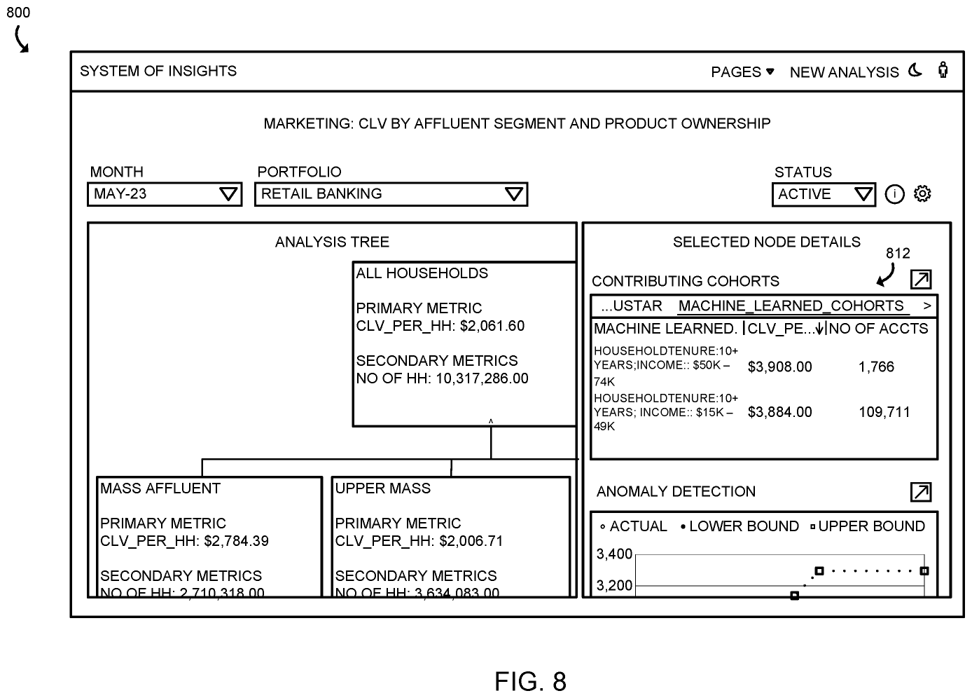

Referring to FIG. 7, in a user interface 700 that may be produced by the insight compute device 110, a view of the data analysis model from FIG. 6 has been shifted such that further nodes 720, 722 are visible in section 710. Nodes 720, 722 feed into node 622, which is also shown in FIG. 6. In the user interface 700, the node 722 has been selected and contributing cohort information and anomaly detection information pertaining to the population associated with the selected node 722 is displayed in corresponding sections 712, 714. The user interface 800 of FIG. 8 represents another data analysis model that may be managed by a user. As shown, in the section 812, cohorts (e.g., attributes of interest) may be identified by the insight compute device 110 through machine learning (e.g., through the execution of one or more machine learning algorithms). As such, the user may rely on the insight compute device 110 to identify attributes of interest (e.g., cohorts) to supplement or replace a user's manual identification of attributes of interest for cohort analysis.

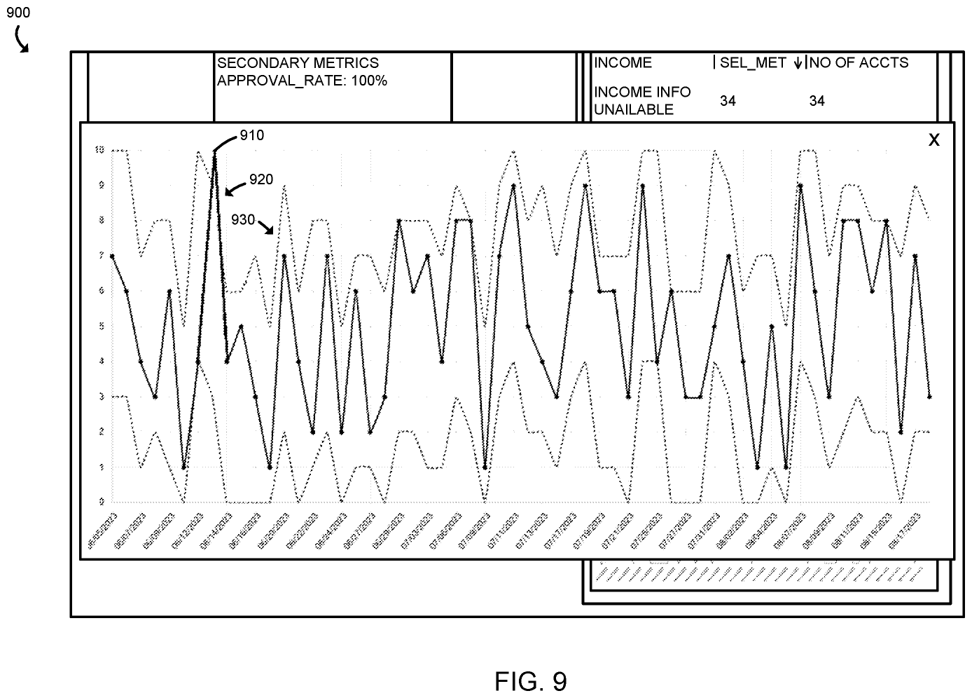

The user interface 900 in FIG. 9 provides an expanded view of anomaly detection information that may be produced by the insight compute device 110. As shown, an outlier 910 (e.g., indicative of an anomaly) is represented. That is, the outlier 910 represents an instance where a data point in an actual value trend line 920 exceeds a corresponding value in an upper bound trend line 930.

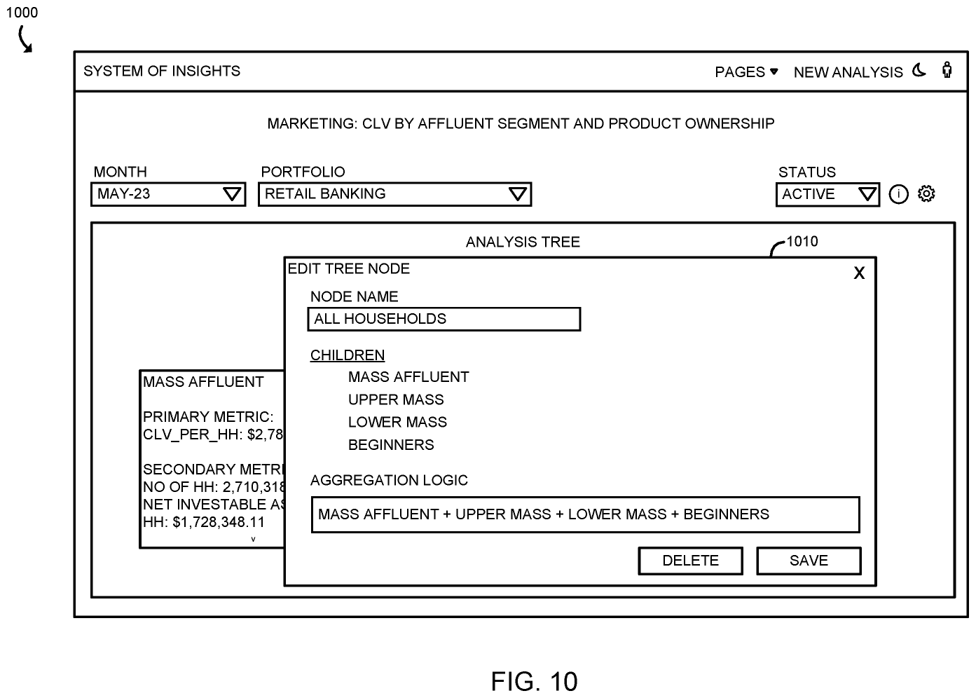

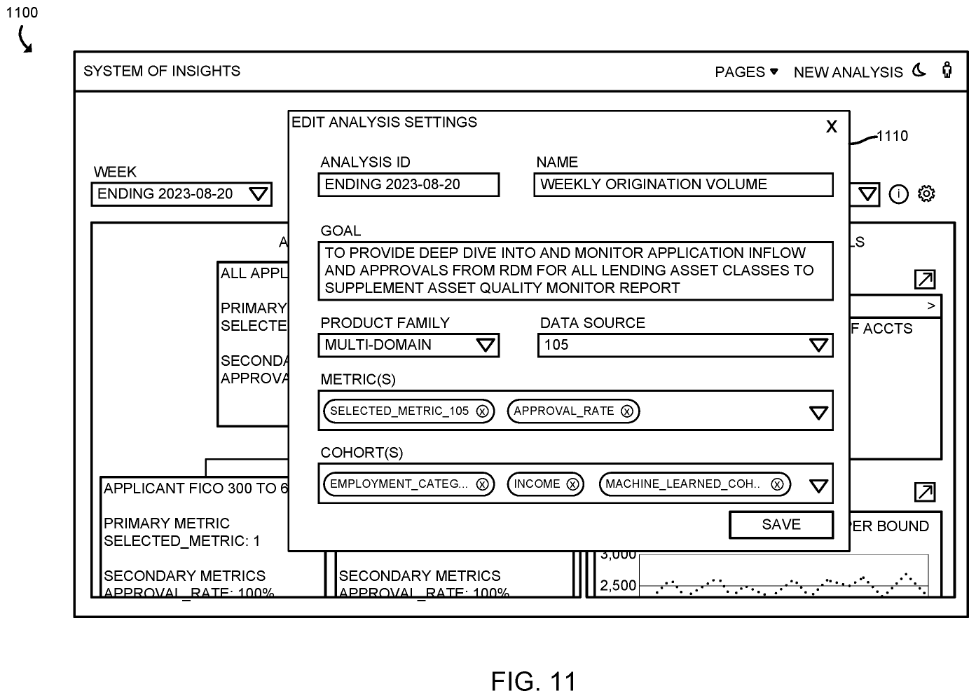

Referring to FIG. 10, an embodiment of a user interface 1000 that may be provided by the insight compute device 110 includes a window 1010 presented in response to user selection of an icon or other user interface element to edit a node of the analysis tree. In the window 1010, the user may edit the name of the node and define aggregation logic. The aggregation logic, in the illustrative embodiment, defines the nodes that feed into the selected node. Referring to FIG. 11, a user interface 1100 that may be provided by the insight compute device 110 includes a window 1110 that enables a user to edit the analysis settings associated with a data analysis model. The window 1110 includes user interface elements to enable the user to specify an analysis ID, a name, a goal, a product family to which the data analysis model pertains, one or more data sources utilized by the data analysis model, metrics represented in the data analysis model, and cohorts (e.g., attributes of interest) utilized by the data analysis model for clustering and cohort analysis.

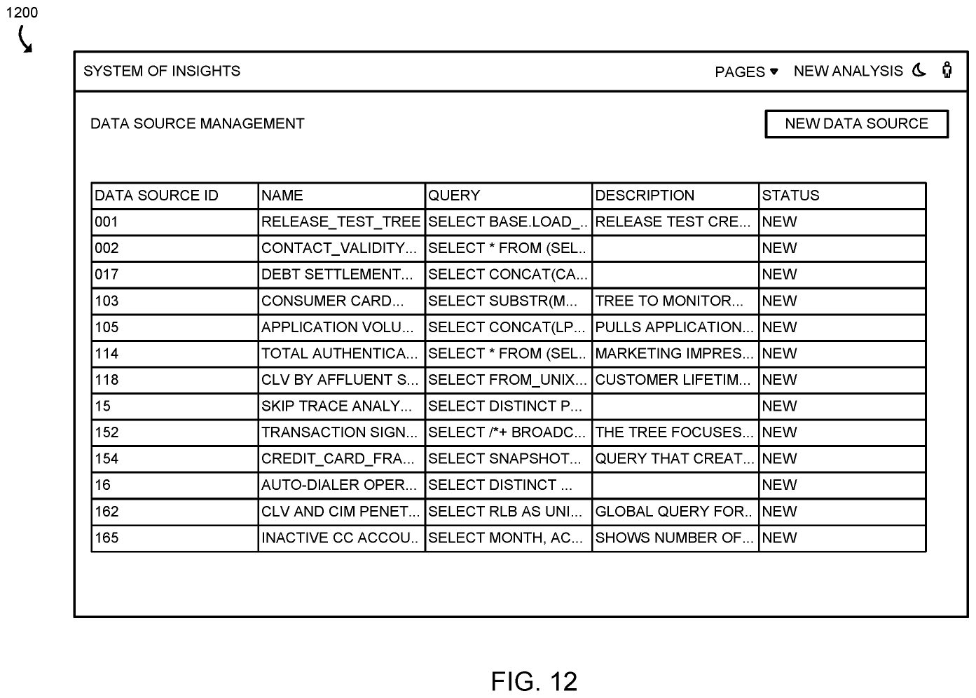

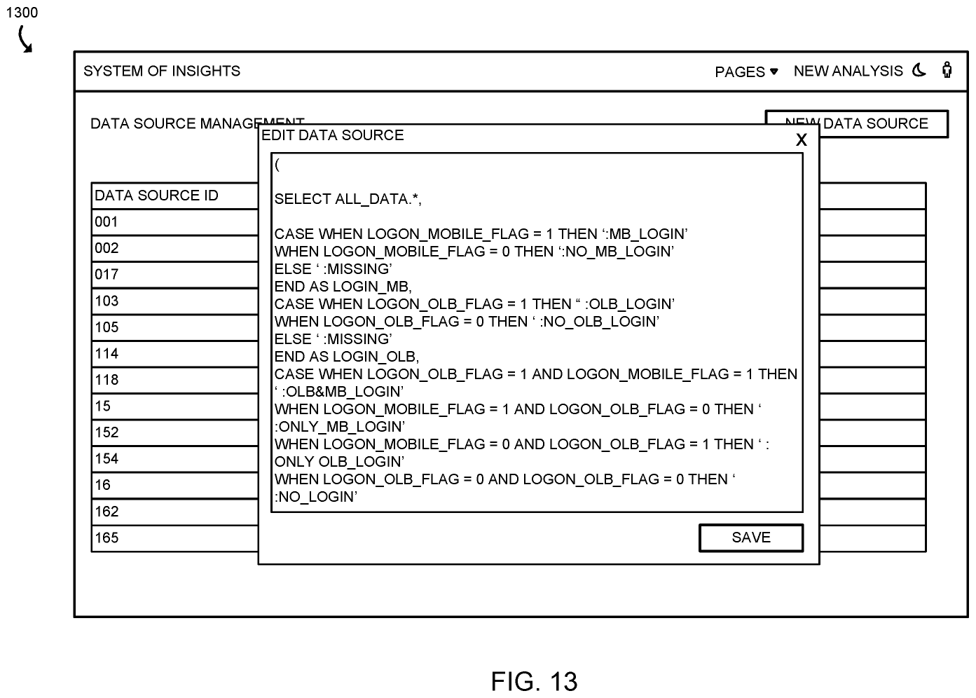

Referring briefly to FIG. 12, an embodiment of a user interface 1200 that may be provided by the insight compute device 110 includes a listing of data sources available for use by data analysis models. In FIG. 13, an embodiment of a user interface 1300 that may be provided by the insight compute device 110 includes a window 1310 in which a user may edit a structured query language (SQL) statement to define the underlying query that provides the data (e.g., from a database) associated with a given data source.

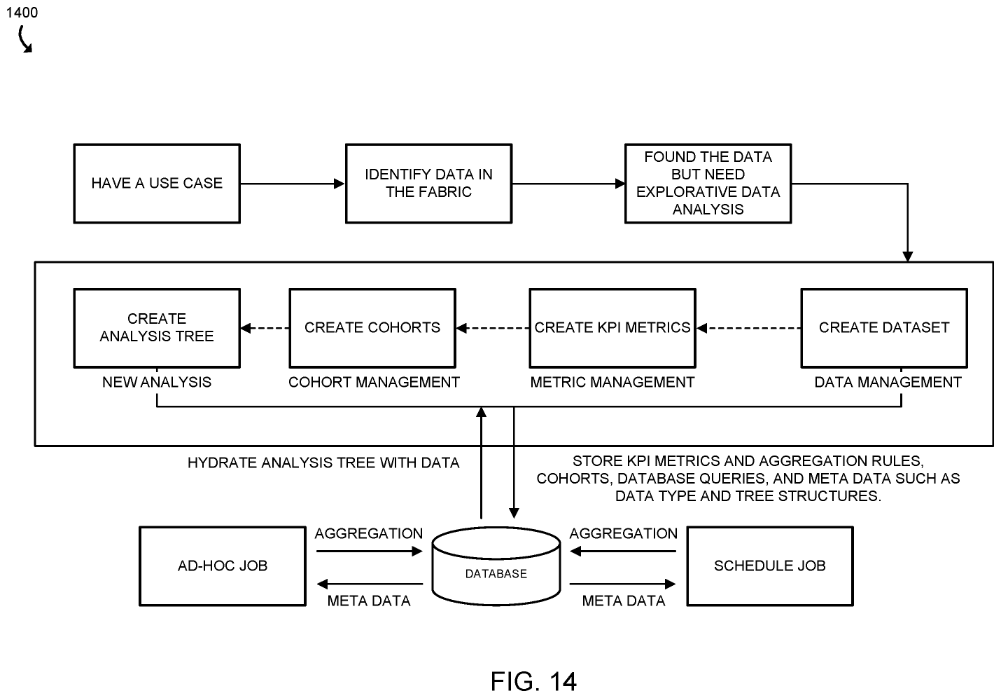

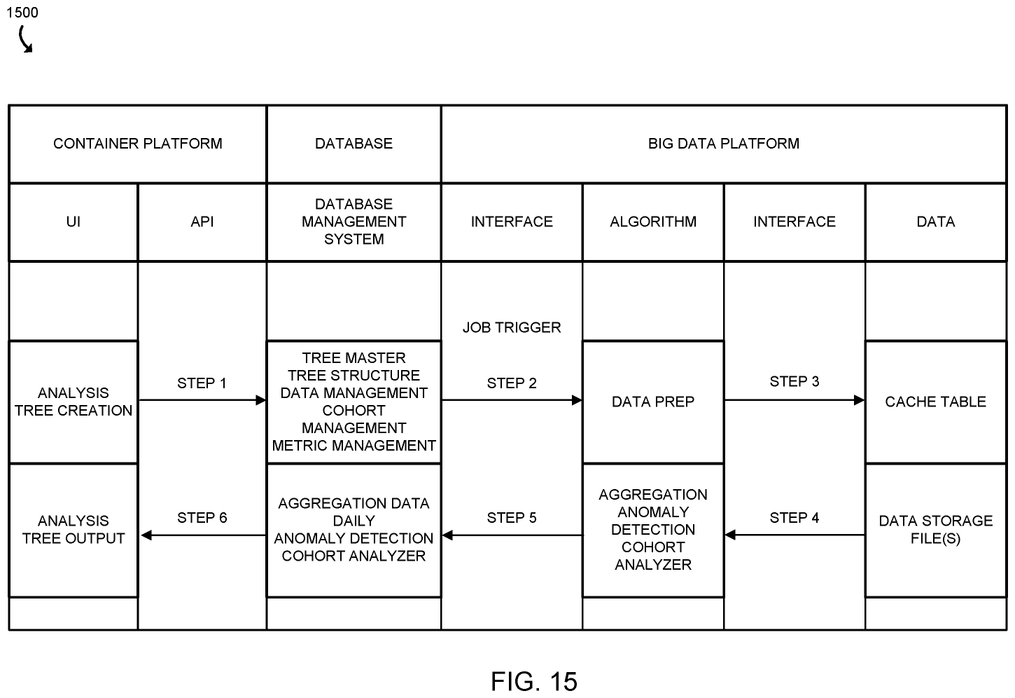

Referring briefly to FIG. 14, a high level diagram 1400 illustrates an example flow of activities that may be performed within an institution to identify the need for a data analysis model, identify the data set(s) and develop the data analysis model, and apply the data analysis model to a database (e.g., as an ad-hoc job and/or a scheduled job). Referring to FIG. 15, a diagram 1500 illustrates a high level flow of operations, from analysis tree creation to analysis tree output, that may be performed using the system 100 of FIG. 1 to efficiently obtain insights from one or more data sets.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain a data analysis model, constructed with a user interface provided by the compute device, to be applied to financial transaction data indicative of financial transactions pertaining to a set of financial accounts; apply the data analysis model to the financial transaction data to identify one or more insights indicative of anomalous behavior; and present the one or more insights in the user interface.

Example 2 includes the subject matter of Example 1, and wherein to obtain a data analysis model constructed with the user interface comprises to obtain a data analysis model from a user interface that enables a user to identify one or more key performance indicators.

Example 3 includes the subject matter of any of Examples 1 and 2, and wherein to obtain a data analysis model constructed with the user interface comprises to obtain a data analysis model from a user interface that enables a user to define one or more attributes of interest based on subject matter expertise.

Example 4 includes the subject matter of any of Examples 1-3, and wherein to obtain a data analysis model constructed with the user interface comprises to obtain a data analysis model from a user interface that enables identification of one or more attributes of interest based on machine learning.

Example 5 includes the subject matter of any of Examples 1-4, and wherein to obtain a data analysis model constructed with the user interface comprises to obtain a data analysis model from a user interface that enables one or more user-defined filters.

Example 6 includes the subject matter of any of Examples 1-5, and wherein to obtain a data analysis model constructed with the user interface comprises to obtain a data analysis model from a user interface that enables creation of a user-defined tree structure indicative of an aggregation hierarchy in which nodes in the tree structure are aggregated to a total population.

Example 7 includes the subject matter of any of Examples 1-6, and wherein to obtain a data analysis model constructed with the user interface comprises to obtain a data analysis model from a user interface that enables addition or editing of one or more data sources.

Example 8 includes the subject matter of any of Examples 1-7, and wherein to obtain a data analysis model constructed with the user interface comprises to obtain a data analysis model from a user interface that enables addition or editing of one or more database queries.

Example 9 includes the subject matter of any of Examples 1-8, and wherein to apply the data analysis model to the financial transaction data comprises to produce clusters of the financial accounts based on similarity in or more attributes associated with the financial accounts.

Example 10 includes the subject matter of any of Examples 1-9, and wherein to apply the data analysis model to the financial transaction data comprises to perform cohort analysis.

Example 11 includes the subject matter of any of Examples 1-10, and wherein to perform cohort analysis comprises to produce one or more summaries of key performance indicators based on the one or more attributes.

Example 12 includes the subject matter of any of Examples 1-11, and wherein to apply the data analysis model to the financial transaction data comprises to identify anomalous behavior within clusters of the financial accounts that have been grouped based on similarity in one or more attributes associated with the financial accounts.

Example 13 includes the subject matter of any of Examples 1-12, and wherein to identify anomalous behavior within the clusters comprises to evaluate time series historical data pertaining to the financial accounts.

Example 14 includes the subject matter of any of Examples 1-13, and wherein the circuitry is further configured to determine one or more thresholds in the time series data.

Example 15 includes the subject matter of any of Examples 1-14, and wherein the circuitry is further configured to identify one or more outliers in a set of time series data that has at least a predefined number of data points.

Example 16 includes the subject matter of any of Examples 1-15, and wherein to present one or more insights in a user interface comprises to present one or more anomalies in the user interface.

Example 17 includes the subject matter of any of Examples 1-16, and wherein to present one or more insights in a user interface comprises to present one or more drivers of one or more key performance indicators.

Example 18 includes the subject matter of any of Examples 1-17, and wherein to present one or more insights in a user interface comprises to enable drill down into financial data underlying an insight.

Example 19 includes a method comprising obtaining, by a compute device, a data analysis model constructed with a user interface provided by the compute device to be applied to financial transaction data indicative of financial transactions pertaining to a set of financial accounts; applying, by the compute device, the data analysis model to the financial transaction data to identify one or more insights indicative of anomalous behavior; and presenting, by the compute device, the one or more insights in the user interface.

Example 20 includes the subject matter of Example 19, and wherein obtaining a data analysis model constructed with the user interface comprises obtaining a data analysis model from a user interface that enables a user to identify one or more key performance indicators.

Example 21 includes the subject matter of any of Examples 19 and 20, and wherein obtaining a data analysis model constructed with the user interface comprises obtaining a data analysis model from a user interface that enables a user to define one or more attributes of interest based on subject matter expertise.

Example 22 includes the subject matter of any of Examples 19-21, and wherein obtaining a data analysis model constructed with the user interface comprises obtaining a data analysis model from a user interface that enables identification of one or more attributes of interest based on machine learning.

Example 23 includes the subject matter of any of Examples 19-22, and wherein obtaining a data analysis model constructed with the user interface comprises obtaining a data analysis model from a user interface that enables one or more user-defined filters.

Example 24 includes the subject matter of any of Examples 19-23, and wherein obtaining a data analysis model constructed with the user interface comprises obtaining a data analysis model from a user interface that enables creation of a user-defined tree structure indicative of an aggregation hierarchy in which nodes in the tree structure are aggregated to a total population.

Example 25 includes the subject matter of any of Examples 19-24, and wherein obtaining a data analysis model constructed with the user interface comprises obtaining a data analysis model from a user interface that enables addition or editing of one or more data sources.

Example 26 includes the subject matter of any of Examples 19-25, and wherein obtaining a data analysis model constructed with the user interface comprises obtaining a data analysis model from a user interface that enables addition or editing of one or more database queries.

Example 27 includes the subject matter of any of Examples 19-26, and wherein applying the data analysis model to the financial transaction data comprises producing clusters of the financial accounts based on similarity in or more attributes associated with the financial accounts.

Example 28 includes the subject matter of any of Examples 19-27, and wherein applying the data analysis model to the financial transaction data comprises performing cohort analysis.

Example 29 includes the subject matter of any of Examples 19-28, and wherein performing cohort analysis comprises producing one or more summaries of key performance indicators based on the one or more attributes.

Example 30 includes the subject matter of any of Examples 19-29, and wherein applying the data analysis model to the financial transaction data comprises identifying anomalous behavior within clusters of the financial accounts that have been grouped based on similarity in one or more attributes associated with the financial accounts.

Example 31 includes the subject matter of any of Examples 19-30, and wherein identifying anomalous behavior within the clusters comprises evaluating time series historical data pertaining to the financial accounts.

Example 32 includes the subject matter of any of Examples 19-31, and further including determining one or more thresholds in the time series data.

Example 33 includes the subject matter of any of Examples 19-32, and further including identifying one or more outliers in a set of time series data that has at least a predefined number of data points.

Example 34 includes the subject matter of any of Examples 19-33, and wherein presenting one or more insights in a user interface comprises presenting one or more anomalies in the user interface.

Example 35 includes the subject matter of any of Examples 19-34, and wherein presenting one or more insights in a user interface comprises presenting one or more drivers of one or more key performance indicators.

Example 36 includes the subject matter of any of Examples 19-35, and wherein presenting one or more insights in a user interface comprises enabling drill down into financial data underlying an insight.

Example 37 includes one or more machine-readable storage media comprising a plurality of instructions stored thereon that, in response to being executed, cause a compute device to obtain a data analysis model, constructed with a user interface provided by the compute device, to be applied to financial transaction data indicative of financial transactions pertaining to a set of financial accounts; apply the data analysis model to the financial transaction data to identify one or more insights indicative of anomalous behavior; and present the one or more insights in the user interface.

Example 38 includes the subject matter of Example 37, and wherein to obtain a data analysis model constructed with the user interface comprises to obtain a data analysis model from a user interface that enables a user to identify one or more key performance indicators.

Example 39 includes the subject matter of any of Examples 37 and 38, and wherein to obtain a data analysis model constructed with the user interface comprises to obtain a data analysis model from a user interface that enables a user to define one or more attributes of interest based on subject matter expertise.

Example 40 includes the subject matter of any of Examples 37-39, and wherein to obtain a data analysis model constructed with the user interface comprises to obtain a data analysis model from a user interface that enables identification of one or more attributes of interest based on machine learning.

Example 41 includes the subject matter of any of Examples 37-40, and wherein to obtain a data analysis model constructed with the user interface comprises to obtain a data analysis model from a user interface that enables one or more user-defined filters.

Example 42 includes the subject matter of any of Examples 37-41, and wherein to obtain a data analysis model constructed with the user interface comprises to obtain a data analysis model from a user interface that enables creation of a user-defined tree structure indicative of an aggregation hierarchy in which nodes in the tree structure are aggregated to a total population.

Example 43 includes the subject matter of any of Examples 37-42, and wherein to obtain a data analysis model constructed with the user interface comprises to obtain a data analysis model from a user interface that enables addition or editing of one or more data sources.

Example 44 includes the subject matter of any of Examples 37-43, and wherein to obtain a data analysis model constructed with the user interface comprises to obtain a data analysis model from a user interface that enables addition or editing of one or more database queries.

Example 45 includes the subject matter of any of Examples 37-44, and wherein to apply the data analysis model to the financial transaction data comprises to produce clusters of the financial accounts based on similarity in or more attributes associated with the financial accounts.

Example 46 includes the subject matter of any of Examples 37-45, and wherein to apply the data analysis model to the financial transaction data comprises to perform cohort analysis.

Example 47 includes the subject matter of any of Examples 37-46, and wherein to perform cohort analysis comprises to produce one or more summaries of key performance indicators based on the one or more attributes.

Example 48 includes the subject matter of any of Examples 37-47, and wherein to apply the data analysis model to the financial transaction data comprises to identify anomalous behavior within clusters of the financial accounts that have been grouped based on similarity in one or more attributes associated with the financial accounts.

Example 49 includes the subject matter of any of Examples 37-48, and wherein to identify anomalous behavior within the clusters comprises to evaluate time series historical data pertaining to the financial accounts.

Example 50 includes the subject matter of any of Examples 37-49, and wherein the instructions additionally cause the compute device to determine one or more thresholds in the time series data.

Example 51 includes the subject matter of any of Examples 37-50, and wherein the instructions additionally cause the compute device to identify one or more outliers in a set of time series data that has at least a predefined number of data points.

Example 52 includes the subject matter of any of Examples 37-51, and wherein to present one or more insights in a user interface comprises to present one or more anomalies in the user interface.

Example 53 includes the subject matter of any of Examples 37-52, and wherein to present one or more insights in a user interface comprises to present one or more drivers of one or more key performance indicators.

Example 54 includes the subject matter of any of Examples 37-53, and wherein to present one or more insights in a user interface comprises to enable drill down into financial data underlying an insight.

1. A compute device comprising:
circuitry configured to:
obtain a data analysis model, constructed with a user interface provided by the compute device, to be applied to financial transaction data indicative of financial transactions pertaining to a set of financial accounts;
apply the data analysis model to the financial transaction data to identify one or more insights indicative of anomalous behavior; and
present the one or more insights in the user interface.

2. The compute device of claim 1, wherein to obtain a data analysis model constructed with the user interface comprises to obtain a data analysis model from a user interface that enables a user to identify one or more key performance indicators.

3. The compute device of claim 1, wherein to obtain a data analysis model constructed with the user interface comprises to obtain a data analysis model from a user interface that enables a user to define one or more attributes of interest based on subject matter expertise.

4. The compute device of claim 1, wherein to obtain a data analysis model constructed with the user interface comprises to obtain a data analysis model from a user interface that enables identification of one or more attributes of interest based on machine learning.

5. The compute device of claim 1, wherein to obtain a data analysis model constructed with the user interface comprises to obtain a data analysis model from a user interface that enables one or more user-defined filters.

6. The compute device of claim 1, wherein to obtain a data analysis model constructed with the user interface comprises to obtain a data analysis model from a user interface that enables creation of a user-defined tree structure indicative of an aggregation hierarchy in which nodes in the tree structure are aggregated to a total population.

7. The compute device of claim 1, wherein to obtain a data analysis model constructed with the user interface comprises to obtain a data analysis model from a user interface that enables addition or editing of one or more data sources.

8. The compute device of claim 1, wherein to obtain a data analysis model constructed with the user interface comprises to obtain a data analysis model from a user interface that enables addition or editing of one or more database queries.

9. The compute device of claim 1, wherein to apply the data analysis model to the financial transaction data comprises to produce clusters of the financial accounts based on similarity in or more attributes associated with the financial accounts.

10. The compute device of claim 1, wherein to apply the data analysis model to the financial transaction data comprises to perform cohort analysis.

11. The compute device of claim 10, wherein to perform cohort analysis comprises to produce one or more summaries of key performance indicators based on the one or more attributes.

12. The compute device of claim 1, wherein to apply the data analysis model to the financial transaction data comprises to identify anomalous behavior within clusters of the financial accounts that have been grouped based on similarity in one or more attributes associated with the financial accounts.

13. The compute device of claim 12, wherein to identify anomalous behavior within the clusters comprises to evaluate time series historical data pertaining to the financial accounts.

14. The compute device of claim 13, wherein the circuitry is further configured to determine one or more thresholds in the time series data.

15. The compute device of claim 13, wherein the circuitry is further configured to identify one or more outliers in a set of time series data that has at least a predefined number of data points.

16. The compute device of claim 1, wherein to present one or more insights in a user interface comprises to present one or more anomalies in the user interface.

17. The compute device of claim 1, wherein to present one or more insights in a user interface comprises to present one or more drivers of one or more key performance indicators.

18. The compute device of claim 1, wherein to present one or more insights in a user interface comprises to enable drill down into financial data underlying an insight.

19. A method comprising:
obtaining, by a compute device, a data analysis model constructed with a user interface provided by the compute device to be applied to financial transaction data indicative of financial transactions pertaining to a set of financial accounts;
applying, by the compute device, the data analysis model to the financial transaction data to identify one or more insights indicative of anomalous behavior; and
presenting, by the compute device, the one or more insights in the user interface.

20. One or more machine-readable storage media comprising a plurality of instructions stored thereon that, in response to being executed, cause a compute device to:
obtain a data analysis model, constructed with a user interface provided by the compute device, to be applied to financial transaction data indicative of financial transactions pertaining to a set of financial accounts;
apply the data analysis model to the financial transaction data to identify one or more insights indicative of anomalous behavior; and
present the one or more insights in the user interface.
